(19) United States
(12) Patent Application Publication
(10) Pub. No.: US 2026/0339452 A1
(43) Pub. Date: Oct. 29, 2026

(54) DISPLAY DEVICE AND METHOD FOR DRIVING THE SAME

(71) Applicant: LG Display Co., Ltd., Seoul (KR)

(72) Inventor: Sung Chul KIM, Paju-si (KR)

(73) Assignee: LG Display Co., Ltd., Seoul (KR)

(21) Appl. No.: 19/634,801

(22) Filed: Mar. 31, 2026

(30) Foreign Application Priority Data
Apr. 29, 2025 (KR) 10-2025-0056386

(51) Int. Cl. G06F 3/041

(52) U.S. Cl. CPC G06F 3/0416; G06F 3/0412

(57) ABSTRACT

Provided is a display device including a display panel including a touchscreen, a driver, and a control unit, wherein the control unit is configured to generate an active area setting value for driving the display panel by distinguishing an active area based on a data signal of a previous frame and a data signal of a current frame, a first touch area setting value for driving the low-frequency driving area at the first driving frequency, and a second touch area setting value for deriving expected touch coordinates based on previous touch coordinates and the current touch coordinates and for driving an area corresponding to the expected touch coordinates at the second driving frequency, and generate a control signal for synchronously controlling the touchscreen and the display panel, and change a driving frequency of the low-frequency driving area from a first driving frequency to a second driving frequency faster than the first driving frequency, when current touch coordinates on the touchscreen corresponds to the low-frequency driving area on the display panel.

### CROSS-REFERENCE TO RELATED APPLICATION(S)

This application claims the benefit of Korean Patent Application No. 10-2025-0056386, filed on Apr. 29, 2025, which is hereby incorporated by reference as if fully set forth herein.

### BACKGROUND

### Technical Field

The present disclosure relates to a display device and a method for driving the same.

### Description of the Related Art

As information technology advances, the market for display devices, which serve as connection media between users and information, is expanding. Accordingly, the use of display devices such as light emitting diode (LED) display devices, quantum dot display (QDD) devices, and liquid crystal display device (LCD) devices is increasing.

Each of the above-mentioned display devices include a display panel including subpixels, a driver that outputs a driving signal for driving the display panel, and a power supply that generates power to be supplied to the display panel or the driver.

In such display devices, when driving signals, for example, scan signals and data signals, are supplied to the subpixels formed in the display panel, selected subpixels transmit light or directly emit light, so that an image may be displayed.

### BRIEF SUMMARY

The present disclosure is directed to a display device and a method of driving the same that, among others, substantially obviate one or more problems due to limitations and disadvantages of the related art.

The present disclosure provides a display device and method for driving the display device that sets an MFP driving area using Touch coordinates.

Additional features of the disclosure will be set forth in part in the description which follows and in part will become apparent to those having ordinary skill in the art upon examination of the following or may be learned from practice of the disclosure. The features of the disclosure may be realized and attained by the structure particularly pointed out in the written description and claims hereof as well as the appended drawings.

As embodied and broadly described herein, a display device includes a display panel including a touchscreen, a driver configured to drive the touchscreen and the display panel, and a control unit configured to control the driver, wherein the control unit is configured to generate an active area setting value for driving the display panel by distinguishing an active area based on a data signal of a previous frame and a data signal of a current frame, generate a first touch area setting value for driving the low-frequency driving area at a first driving frequency, derive expected touch coordinates based on previous touch coordinates and the current touch coordinates, and generate a second touch area setting value for driving an area corresponding to the expected touch coordinates at a second driving frequency faster than the first driving frequency, and generate a control signal for synchronously controlling the touchscreen and the display panel based on the active area setting value, the first touch area setting value, and the second touch area setting value, and change a driving frequency of the low-frequency driving area from the first driving frequency to the second driving frequency, when current touch coordinates on the touchscreen corresponds to the low-frequency driving area on the display panel.

The control unit may change a part or all of the low-frequency driving area to the second driving frequency based on the current touch coordinates corresponding to the low-frequency driving area.

The control unit may include an active area setting unit configured to generate the active area setting value, a touch area setting unit configured to generate the first touch area setting value and the second touch area setting value, a control area setting unit configured to generate a device control signal based on the active area setting value, the first touch area setting value, and the second touch area setting value, and a control signal generation unit configured to generate a panel control signal and a touch control signal for synchronously driving the display panel and the touchscreen based on the device control signal.

The control unit may divide the display panel into a plurality of active areas and drive at least one of the divided active areas at multiple different driving frequencies.

The control unit may generate the control signal such that an area displaying a still image on the display panel is driven at the first driving frequency, and an area displaying a moving image on the display panel is driven at the second driving frequency.

The display device may further include a touch driver configured to drive the touchscreen, wherein the touch driver senses an area driven at the first driving frequency in fewer frame units than frame units of an area driven at the second driving frequency.

The control unit may continuously store the previous touch coordinates, derive the expected touch coordinates by performing data processing on a plurality of stored previous touch coordinates and the current touch coordinates based on modeled values, and the modeled values may be prepared based on a movement position of coordinates and a movement speed of coordinates.

In another aspect of the present disclosure, a method of driving a display device includes generating an active area setting value for driving a display panel by distinguishing an active area of the display panel based on a data signal of a previous frame and a data signal of a current frame, generating a first touch area setting value for driving a low-frequency driving area on the display panel at a first driving frequency, deriving expected touch coordinates on a touchscreen based on previous touch coordinates and current touch coordinates, and generating a second touch area setting value for driving an area corresponding to the expected touch coordinates at a second driving frequency faster than the first driving frequency, generating a control signal for synchronously controlling the touchscreen and the display panel based on the active area setting value, the first touch area setting value, and the second touch area setting value, and changing a driving frequency of the low-frequency driving area from the first driving frequency to the second driving frequency, when the current touch coordinates on the touchscreen corresponds to the low-frequency driving area on the display panel.

Based on the current touch coordinates corresponding to the low-frequency driving area, a part or all of the low-frequency driving area may be changed to the second driving frequency.

An area displaying a still image on the display panel may be driven at the first driving frequency, and an area displaying a moving image on the display panel may be driven at the second driving frequency.

It is to be understood that both the foregoing general description and the following detailed description of the present disclosure are illustrative and explanatory and provide further explanation of the claims.

### BRIEF DESCRIPTION OF THE SEVERAL VIEWS OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram schematically illustrating the LED display device including the touchscreen;

FIGS. 2 and 3 are diagrams for describing a configuration of a gate-in-panel (GIP) type gate driver;

FIG. 4 is an example diagram illustrating a smartphone implemented based on the LED display device including the touchscreen illustrated in FIG. 1, and FIG. 5 is a diagram illustrating a schematic configuration of the touchscreen;

FIG. 6 is a diagram illustrating a display panel and a touchscreen separately to describe the LED display device including the touchscreen according to an embodiment, FIG. 7 is a first example diagram for describing a driving method according to an embodiment, FIG. 8 is a second example diagram for describing a driving method according to an embodiment, and FIG. 9 is a diagram for describing a method of predicting a change in touch input of a user;

FIG. 10 is a diagram illustrating a configuration of the timing controller for implementing the LED display device including the touchscreen according to an embodiment, FIG. 11 is a diagram for describing an operation of the timing controller according to an embodiment, and FIG. 12 is a diagram for facilitating understanding of an area-setting method based on an operation of the timing controller according to an embodiment;

FIG. 13 is a diagram for describing a change in touch frame according to area setting of the display panel including the touchscreen, FIG. 14 is a diagram for describing a problem that may be caused when the display panel is driven at a low frequency, and FIG. 15 is a diagram for describing a difference in power of drawing expression according to driving frequencies of the display panel and the touchscreen; and

FIG. 16 is a diagram for describing a display panel including a touchscreen according to a comparative example, and FIG. 17 is a diagram for describing a display panel including a touchscreen according to an embodiment.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

A display device according to the present disclosure may be implemented as a television, a video player, a personal computer (PC), a home theater system, an automotive electronic device, a smartphone, etc., but is not limited thereto. The display device according to the present disclosure may be implemented as a light emitting display (LED) device, a quantum dot display device (QDD), a liquid crystal display device (LCD), etc. However, for convenience of description, an LED display device that directly emits light based on an inorganic light emitting diode or an organic light emitting diode is described as an example below.

In addition, the LED display device described below may include a touchscreen capable of receiving a touch input using a finger of a user, a pen, etc. The touchscreen may be implemented using a capacitive method, etc., but is not limited thereto.

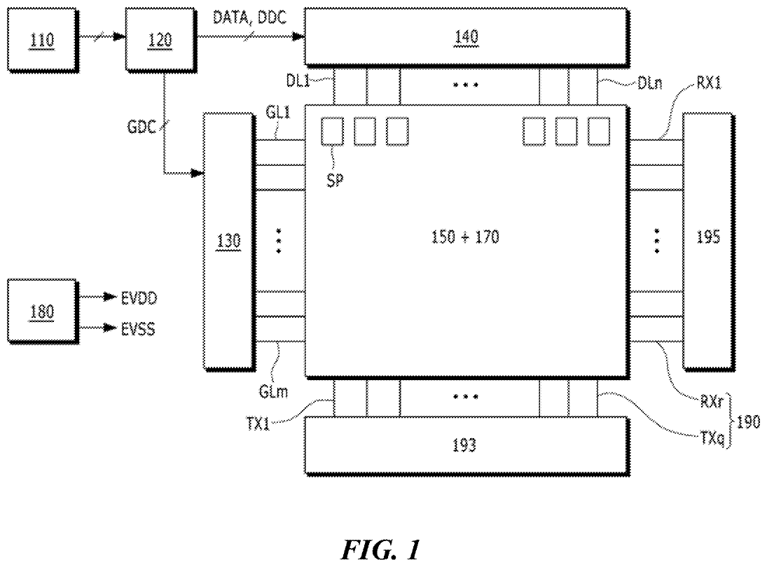

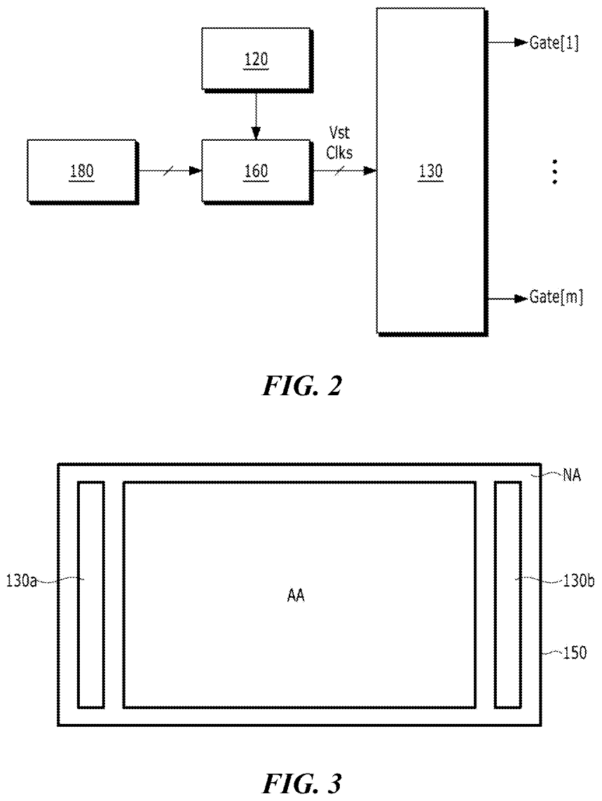

FIG. 1 is a block diagram schematically illustrating the LED display device including the touchscreen, and FIGS. 2 and 3 are diagrams for describing a configuration of a GIP gate driver.

As illustrated in FIGS. 1 to 3, the display device including the touchscreen may include a timing controller 120, a gate driver 130, a data driver 140, a display panel 150, a touchscreen 170, a power supply 180, and a touch driver 190.

The image supplier (set or host system) 110 may output image data signals supplied from an external source or image data signals stored in an internal memory, together with various driving signals. The image supplier 110 may supply the data signals and the various driving signals to the timing controller 120.

The timing controller 120 may output a gate timing control signal GDC for controlling an operation timing of the gate driver 130, a data timing control signal DDC for controlling an operation timing of the data driver 140, various synchronization signals (a vertical synchronization signal Vsync and a horizontal synchronization signal Hsync), etc.

The timing controller 120 may supply a data signal DATA supplied from the image supplier 110 together with the data timing control signal DDC to the data driver 140. The timing controller 120 may be formed as an IC (Integrated Circuit) and mounted on a printed circuit board, but is not limited thereto.

The gate driver 130 may output a gate signal (or gate voltage) in response to the gate timing control signal GDC supplied from the timing controller 120. The gate driver 130 may supply gate signals to subpixels included in the display panel 150 through gate lines GL1 to GLm (where m is an integer greater than or equal to 2).

The gate driver 130 may be formed as an IC or may be directly formed on the display panel 150 in a GIP structure, but is not limited thereto. However, hereinafter, for convenience of description, a GIP gate driver is described as an example as in FIGS. 2 and 3.

The GIP gate driver 130 may include shift registers 130a and 130b formed in a GIP structure on one side and the other side of a non-active area NA of the display panel 150. The shift registers 130a and 130b may be formed in a thin-film form on the non-active area NA of the display panel 150 using GIP technology.

The GIP gate driver 130 may output gate signals capable of turning on or turning off transistors formed in an active area AA of the display panel 150. The GIP gate driver 130 may operate based on signals and voltages output from the timing controller 120, the power supply 180, and a level shifter 160.

The level shifter 160 may generate gate control signals required for driving the GIP gate drivers 130, 130a, and 130b based on signals and voltages output from the timing controller 120 and the power supply 180.

The data driver 140 may sample and latch the data signal DATA in response to the data timing control signal DDC supplied from the timing controller 120, and may convert a digital data signal into an analog data voltage based on gamma reference voltages and output the converted analog data voltage.

The data driver 140 may supply the data voltages to the subpixels included in the display panel 150 through data lines DL1 to DLn (where n is an integer greater than or equal to 2). The data driver 140 may be formed as an IC and mounted on the display panel 150 or mounted on a printed circuit board, but is not limited thereto.

The power supply 180 may generate a high-potential voltage and a low-potential voltage based on an external input voltage supplied from the outside, and may output the generated voltages through a high-potential voltage line EVDD and a low-potential voltage line EVSS. The power supply 180 may generate and output not only the high-potential voltage and the low-potential voltage, but also voltages required for driving the gate driver 130 or voltages required for driving the data driver 140.

The display panel 150 may be manufactured based on a substrate having rigidity or flexibility, such as glass, silicon, or polyimide. The display panel 150 may include a plurality of subpixels SP for displaying an image. The subpixels SP may directly emit light toward an upper substrate, a lower substrate, or both the upper substrate and the lower substrate of the display panel 150.

The subpixel SP may emit light of one of colors such as red, green, blue, or white. The display panel 150 may display an image based on pixels each including a red subpixel, a green subpixel, and a blue subpixel, or pixels each including a red subpixel, a green subpixel, a blue subpixel, and a white subpixel.

The touchscreen 170 may be positioned on the display panel 150, included in the display panel 150, or integrally formed with the display panel 150. The touchscreen 170 may receive a touch input using a finger of a user, a pen, etc. The touchscreen 170 may include, as a configuration for touch sensing, first touch driving lines TX1 to TXq (where q is an integer greater than or equal to 2), and second touch driving lines RX1 to RXr (where r is an integer greater than or equal to 2).

The touch driver 190 may drive and sense the touchscreen 170 in response to a touch control signal supplied from the timing controller 120. The touch driver 190 may include a first touch driver 193 and a second touch driver 195 for driving and sensing the touchscreen 170.

The first touch driver 193 may apply signals to the first touch driving lines TX1 to TXq to drive the touchscreen 170. The second touch driver 195 may sense the second touch driving lines RX1 to RXr to sense the touchscreen 170.

Meanwhile, in the above description, the timing controller 120, the gate driver 130, the data driver 140, and the touch driver 190 are described as separate components, respectively. However, depending on the implementation method of the LED display device, one or more of the timing controller 120, the gate driver 130, the data driver 140, and the touch driver 190 may be integrated into a single IC.

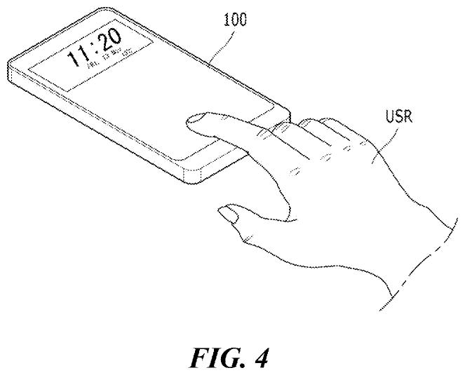

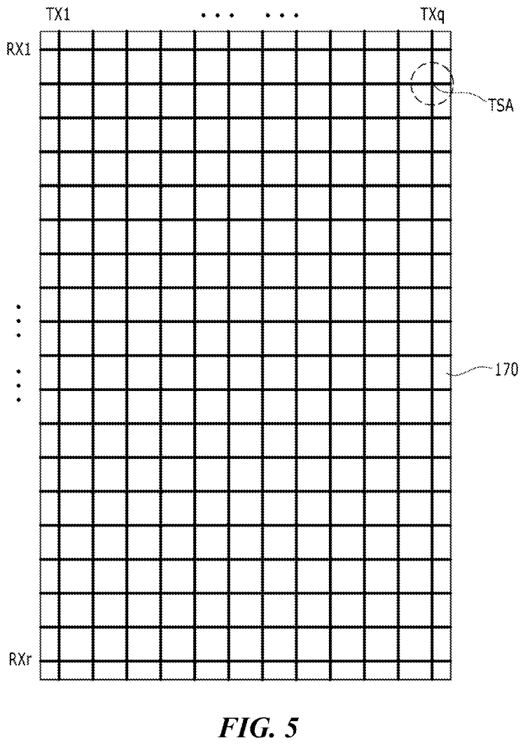

FIG. 4 is an example diagram illustrating a smartphone implemented based on the LED display device including the touchscreen illustrated in FIG. 1, and FIG. 5 is a diagram illustrating a schematic configuration of the touchscreen.

As illustrated in FIG. 4, the LED display device including the touchscreen illustrated in FIG. 1 may be implemented as a smartphone 100, etc. The smartphone 100 may receive input from a user USR using a finger, a pen, etc., and may execute an application corresponding to the input and display the application on the display panel.

As illustrated in FIG. 5, the touchscreen 170 may include touch sensors defined between a plurality of first touch driving lines TX1 to TXq (where q is an integer greater than or equal to 2) arranged in a vertical direction, and a plurality of second touch driving lines RX1 to RXr (where r is an integer greater than or equal to 2) arranged in a horizontal direction.

One touch sensor TSA for performing touch sensing in the touchscreen 170 may be defined in an intersection area of one first touch driving line and one second touch driving line. The touchscreen 170 may be implemented in a capacitive manner capable of determining whether a touch is present based on whether a capacitance change occurs, but is not limited thereto.

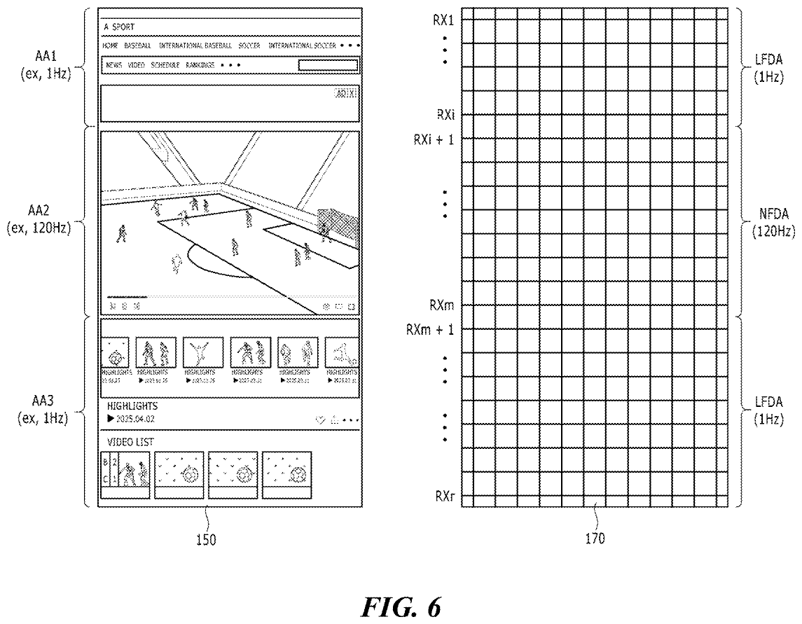

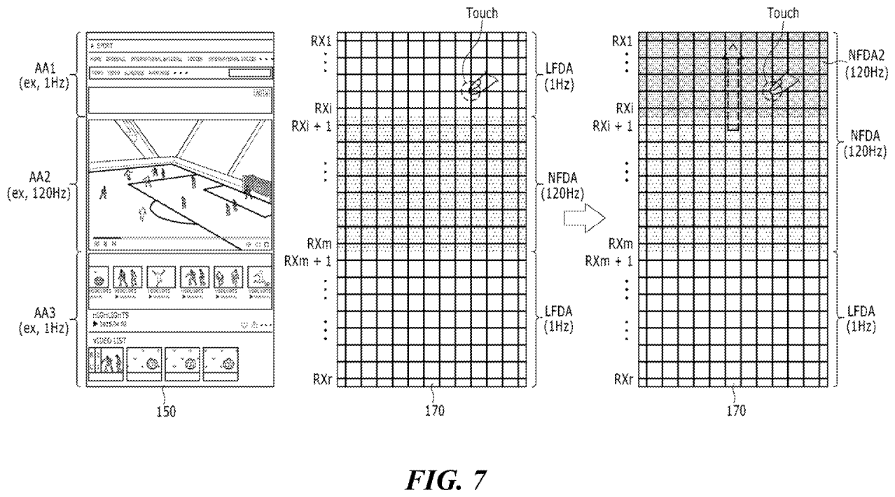

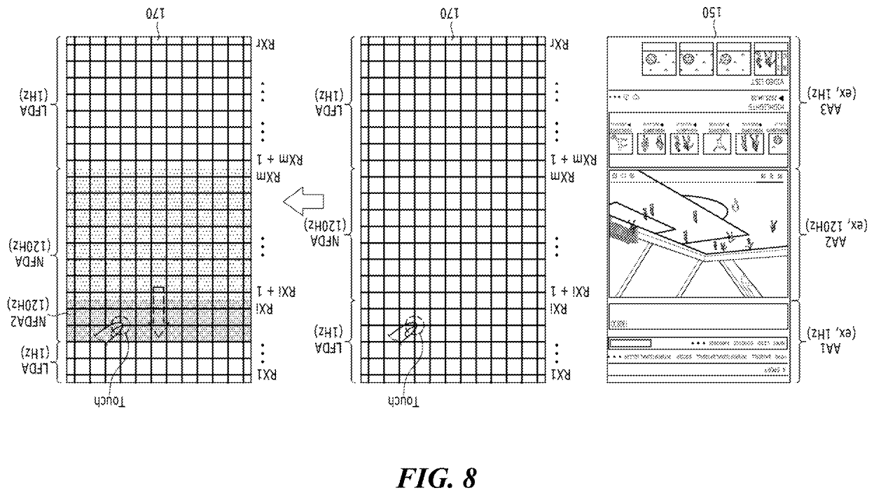

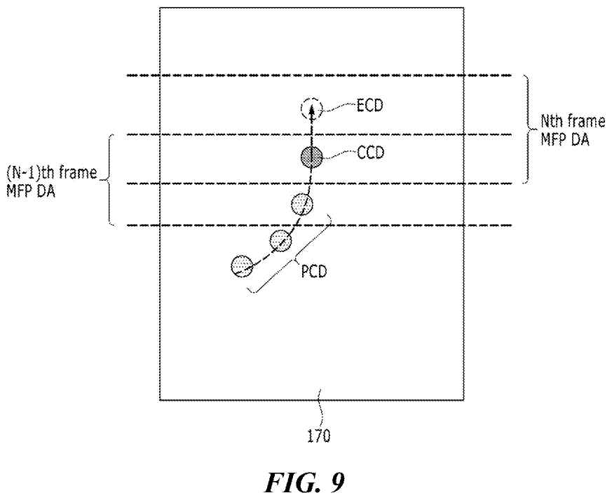

FIG. 6 is a diagram illustrating a display panel and a touchscreen separately to describe the LED display device including the touchscreen according to an embodiment, FIG. 7 is a first example diagram for describing a driving method according to an embodiment, FIG. 8 is a second example diagram for describing a driving method according to an embodiment, and FIG. 9 is a diagram for describing a method of predicting a change in touch input of the user.

As illustrated in FIG. 6, the LED display device including the touchscreen according to an embodiment may divide the active area in which images are displayed on a display panel 150 into a plurality of display parts, and may drive the plurality of divided display parts at one or more different driving frequencies (multiple driving frequencies).

For example, the display panel 150 may include a first active area AA1 driven at a first driving frequency (for example, 1 Hz), a second active area AA2 driven at a second driving frequency (for example, 120 Hz), and a third active area AA3 driven at the first driving frequency (for example, 1 Hz, or a driving frequency between 1 Hz and 120 Hz). Meanwhile, the driving frequencies illustrated in FIG. 6 are merely examples, and various frequency bands may be selected.

The first active area AA1 and the third active area AA3, which are driven at a low driving frequency such as the first driving frequency (for example, 1 Hz), may correspond to areas for displaying a still image, and the second active area AA2, which is driven at a high driving frequency such as the second driving frequency (for example, 120 Hz), may correspond to an area for displaying a moving image.

The touchscreen 170 may also be divided into three touch areas corresponding to the display panel 150. In addition, areas of the touchscreen 170 corresponding to the first active area AA1 and the third active area AA3 may be defined as a first driving frequency driving area LFDA (low-frequency driving area), and an area corresponding to the second active area AA2 may be defined as a second driving frequency driving area NFDA (normal-frequency or high-frequency driving area).

Meanwhile, in FIG. 6, an example has been described in which the display panel 150 is divided in a vertical direction into an upper area, a middle area, and a lower area and is driven accordingly. However, the display panel 150 may be divided in a horizontal direction into a left area, a central area, and a right area and driven accordingly, or may be divided and driven in a mixed form of the vertical direction and the horizontal direction. However, hereinafter, for convenience of description, an example divided as illustrated in FIG. 6 will be described.

As can be understood from the above description, the display panel 150 and the touchscreen 170 may be driven at various frequencies, and driving frequencies for driving the display panel 150 and the touchscreen 170 may be synchronized, and the driving frequencies may be changed in a synchronized state, which will be described as follows.

As illustrated in FIG. 7 and FIG. 8, the display panel 150 may include the first active area AA1 and the third active area AA3 driven at the first driving frequency (for example, 1 Hz), and the second active area AA2 driven at the second driving frequency (for example, 120 Hz).

The touchscreen 170 may include the first driving frequency driving area LFDA that operates corresponding to the first driving frequency (for example, 1 Hz) of the display panel 150, and the second driving frequency driving area NFDA that operates corresponding to the second driving frequency (for example, 120 Hz) of the display panel 150.

According to a first example of FIG. 7, the user may touch a portion of the first driving frequency driving area LFDA of the touchscreen 170 corresponding to the first active area AA1 of the display panel 150 during an (N−1)th frame.

In this case, during an Nth frame corresponding to a frame following the (N−1)th frame, the first driving frequency driving area LFDA of the touchscreen 170 corresponding to the first active area AA1 of the display panel 150 may be changed such that the entire area becomes a new second driving frequency driving area NFDA2 (or expanded to the second driving frequency driving area). Further, the first active area AA1 of the display panel 150 may operate based on the same second driving frequency (for example, 120 Hz) as that of the new second driving frequency driving area NFDA2.

As in a second example of FIG. 8, the user may touch a part of the first driving frequency driving area LFDA of the touchscreen 170 corresponding to the first active area AA1 of the display panel 150 during the (N−1)th frame.

In this case, during the Nth frame corresponding to the frame following the (N−1)th frame, a part of the first driving frequency driving area LFDA of the touchscreen 170 corresponding to the first active area AA1 of the display panel 150 may be changed to a new second driving frequency driving area NFDA2 (or expanded to the second driving frequency driving area). Correspondingly, a part of the first active area AA1 of the display panel 150 (an untouched area and a surrounding area thereof) may operate based on the same first driving frequency (for example, 1 Hz) as that of the first driving frequency driving area LFDA, and another part (a touched area and a surrounding area thereof) may operate based on the same second driving frequency (for example, 120 Hz) as that of the new second driving frequency driving area NFDA2.

Meanwhile, the first driving frequency driving area LFDA of the touchscreen 170 may be changed to a new second driving frequency driving area NFDA2 (or expanded to the second driving frequency driving area) by user touch as in the first example of FIG. 7, or may be reset (reduction of the first driving frequency driving area) by user touch as in the second example of FIG. 8.

As can be understood from the two examples illustrated in FIG. 7 and FIG. 8, the LED display device including the touchscreen according to an embodiment may drive a part of the touchscreen 170 at a low frequency corresponding to an area of the display panel 150 that displays a still image, in order to reduce power consumption.

However, when user touch occurs in an area driven at a low frequency, the area driven at the low frequency may be changed to a normal-frequency or high-frequency driving condition in order to smoothly sense the user touch input and reflect the touch input in operation of the device.

In addition, based on a change in the user touch input (for example, a movement path of the finger), a driving frequency for an entire first driving frequency driving area LFDA of the touchscreen 170 may be changed as illustrated in FIG. 7, or a driving frequency for a part of the first driving frequency driving area LFDA of the touchscreen 170 may be changed as illustrated in FIG. 8.

As illustrated in FIG. 9, a change in the user touch input (for example, a movement path of the finger) may be predicted based on touch input of the (N−1)th frame ((N−1)th frame MFP DA) and touch input of the Nth frame (Nth frame MFP DA).

Previous touch coordinates PCD, current touch coordinates CCD, and expected touch coordinates ECD may be included between the touch input of the (N−1)th frame ((N−1)th frame MFP DA) and the touch input of the Nth frame (Nth frame MFP DA). Here, note that the previous touch coordinates PCD represents a total of three previous touch values considering from the (N−1)th frame to an (N−3)th frame.

By continuously storing previous touch coordinates PCD and performing data processing on the plurality of stored previous touch coordinates PCD and current touch coordinates CCD based on modeled values (values modeled by a movement position of coordinates, a movement speed of coordinates, etc.), a change in user touch input may be predicted, and the expected touch coordinates ECD may be derived based on the prediction. However, a method of predicting a change in the user touch input is merely an example and is not limited thereto.

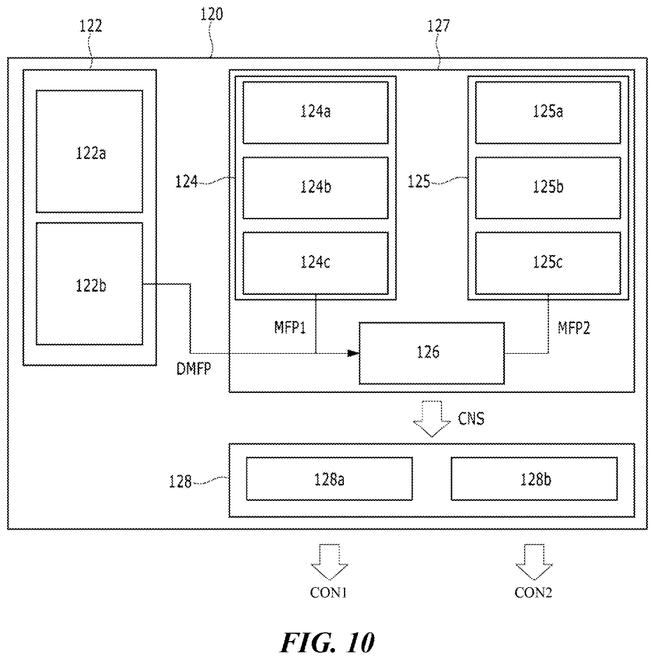

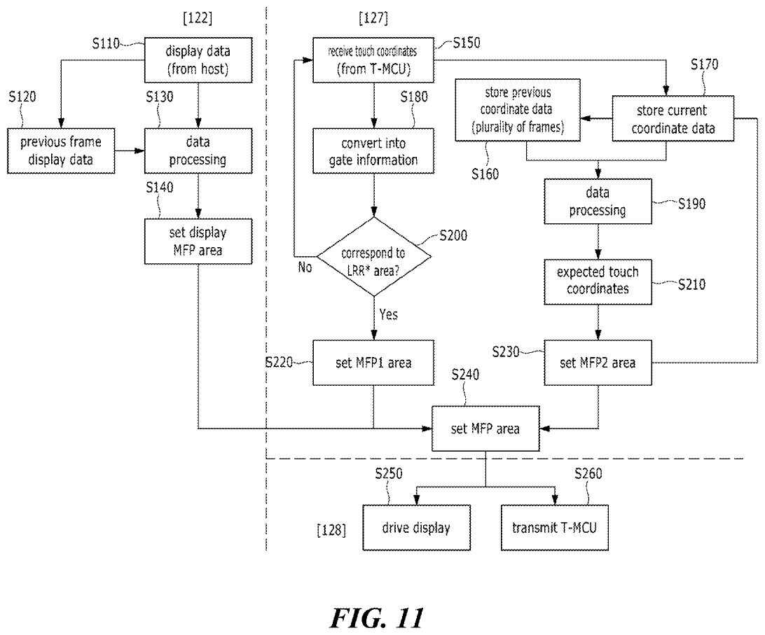

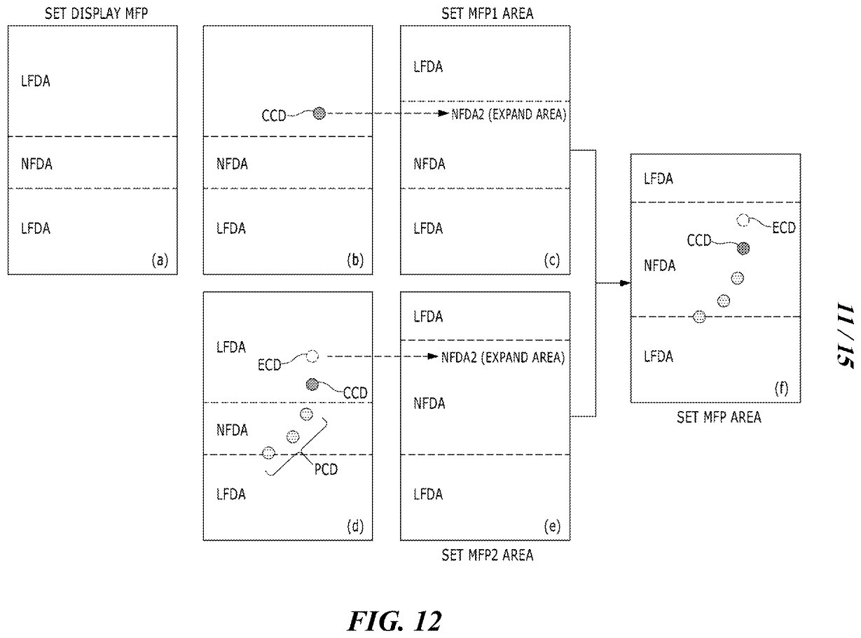

FIG. 10 is a diagram illustrating a configuration of the timing controller for implementing the LED display device including the touchscreen according to an embodiment, FIG. 11 is a diagram for describing an operation of the timing controller according to an embodiment, and FIG. 12 is a diagram for facilitating understanding of an area-setting method based on an operation of the timing controller according to an embodiment.

As illustrated in FIG. 10, the timing controller 120 for implementing the LED display device including the touchscreen according to an embodiment may include an active area setting unit 122, a touch area setting unit 127, and a control signal generation unit 128.

The active area setting unit 122 may perform data processing on a data signal of a previous frame and a data signal of a current frame supplied from an external device (for example, a host system) to set an active area for driving the display panel based on multiple driving frequencies.

The active area setting unit 122 may include a first active area setting unit 122a and a second active area setting unit 122b. The first active area setting unit 122a may perform image processing on a data signal of the previous frame and a data signal of the current frame to generate an image processing result value. The second active area setting unit 122b may generate an active area setting value DMFP by distinguishing, on the display panel, an active area in which an image changes (for example, a moving image) and an active area in which an image does not change (for example, a still image), based on the image processing result value.

The touch area setting unit 127 may convert the current touch coordinates on the touchscreen into gate signal information on the display panel and then determine whether the current touch coordinates correspond to an area corresponding to an LRR (Low Refresh Rate) area (or a low-frequency driving area). In this case, when the current touch coordinates correspond to the LRR area, the touch area setting unit 127 may generate a first touch area setting value MFP1 for driving the corresponding area at a first driving frequency.

In addition, the touch area setting unit 127 may derive expected touch coordinates by performing data processing on the previous touch coordinates (or touch coordinate data) and the current touch coordinates, and may generate a second touch area setting value MFP2 for driving an area corresponding to the expected touch coordinates at the second driving frequency.

The touch area setting unit 127 may include a first touch area setting unit 124, a second touch area setting unit 125, and a control area setting unit 126. The touch area setting unit 127 may receive touch coordinates from the touch driver. Meanwhile, even though the control area setting unit 126 is illustrated as being included in the touch area setting unit 127 as an example, the control area setting unit 126 may be separated as an independent component, similar to the control signal generation unit 128.

The first touch area setting unit 124 may include a 1-1th touch area setting unit 124a that converts the current touch coordinates on the touchscreen into gate signal information on the display panel, a 1-2th touch area setting unit 124b that determines whether the current touch coordinates correspond to an area corresponding to the LRR area (or the low-frequency driving area), and a 1-3th touch area setting unit 124c that generates the first touch area setting value MFP 1 for driving the corresponding area at the first driving frequency when the current touch coordinates correspond to the LRR area.

The second touch area setting unit 125 may include a 2-1th touch area setting unit 125a that stores the previous touch coordinates (or touch coordinate data) and the current touch coordinates, a 2-2th touch area setting unit 125b that derives expected touch coordinates by performing data processing on the previous touch coordinate (or touch coordinate data) and the current touch coordinates, and a 2-3th touch area setting unit 125c that generates the second touch area setting value MFP2 for driving an area corresponding to the expected touch coordinates at the second driving frequency.

The control area setting unit 126 may generate a device control signal CNS for synchronously driving the display panel and the touchscreen based on the active area setting value DMFP generated by the active area setting unit 122, the first touch area setting value MFP1 generated by the first touch area setting unit 124, and the second touch area setting value MFP2 generated by the second touch area setting unit 125.

The control signal generation unit 128 may generate control signals for controlling the display panel and the touchscreen based on the device control signal CNS generated by the control area setting unit 126. The control signal generation unit 128 may include a panel control signal generation unit 128a and a touch control signal generation unit 128b.

The panel control signal generation unit 128a may generate a panel control signal CON1 for controlling the gate driver and the data driver that drive the display panel based on the device control signal CNS. The touch control signal generation unit 128b may generate a touch control signal CON2 for controlling the touch driver that drives the touchscreen based on the device control signal CNS.

As illustrated in FIG. 10, FIG. 11, and FIG. 12, the active area setting unit 122, the touch area setting unit 127, the control area setting unit 126, and the control signal generation unit 128 included in the timing controller 120 may operate according to the following flow.

The active area setting unit 122 may receive a data signal (display data) of a current frame to be displayed on the display panel from a host system (from Host) (S110), and may store a data signal of a previous frame supplied therefrom (S120).

The active area setting unit 122 may perform data processing on the data signal of the previous frame and the data signal of the current frame (S130) to generate the active area setting value DMFP for setting (which may be defined as a display MFP area setting scheme) and driving an active area of the display panel based on multiple driving frequencies (S140).

The touch area setting unit 127 may receive touch coordinates of the touchscreen from the touch driver (from T-MCU) (S150), and may store the previous touch coordinates (previous coordinate data) and the current touch coordinates (current coordinate data) (S160 and S170).

The touch area setting unit 127 may convert the current touch coordinates on the touchscreen into gate signal information on the display panel (conversion into gate information) (S180), and may determine whether the current touch coordinates correspond to an area corresponding to an LRR*(Low Refresh Rate) area (or a low-frequency driving area) (S200).

In this case, when the current touch coordinates correspond to the LRR*area (Yes), it is possible to generate a first touch area setting value MFP1 for driving the corresponding area at the first driving frequency (which may be defined as an MFP1 area setting scheme) (S220). However, when the current touch coordinates do not correspond to the LRR* area (No), the process may return to a step of receiving the touch coordinates of the touchscreen from the touch driver (from T-MCU) (S150).

The touch area setting unit 127 may perform data processing on the previous touch coordinates (previous coordinate data) and the current touch coordinates (current coordinate data) (S190) to derive expected touch coordinates (S210), and may generate the second touch area setting value MFP2 for driving an area corresponding to the expected touch coordinates at the second driving frequency (which may be defined as an MFP2 area setting scheme) (S230).

The control area setting unit 126 may set an integrated control area (MFP area setting) for synchronously driving the display panel and the touchscreen in an integrated manner based on the active area setting value DMFP generated by the active area setting unit 122, and the first and second touch area setting values MFP1 and MFP2 generated by the touch area setting unit 127 (S240).

The control area setting unit 126 may generate the device control signal CNS based on the integrated control area setting information (which may be defined as an MFP area setting scheme). By generating the device control signal CNS that may set the integrated control area by synchronizing touch coordinate data of the touchscreen with the active area of the display panel, the control area setting unit 126 may improve performance of the touchscreen, which will be described below.

The control signal generation unit 128 may generate the panel control signal CON1 for controlling the gate driver and the data driver based on the device control signal CNS generated by the control area setting unit 126, and may drive the display panel based thereon (display driving) (S250).

The above description may be easily understood by referring together to the active area setting (display MFP area setting) scheme illustrated in FIG. 12(a), the first touch area setting (MFP1 area setting) scheme illustrated in FIG. 12(b) and 12(c), the second touch area setting (MFP2 area setting) scheme illustrated in FIG. 12(d) and 12(e), and the integrated control area setting (MFP area setting) scheme illustrated in FIG. 12(f).

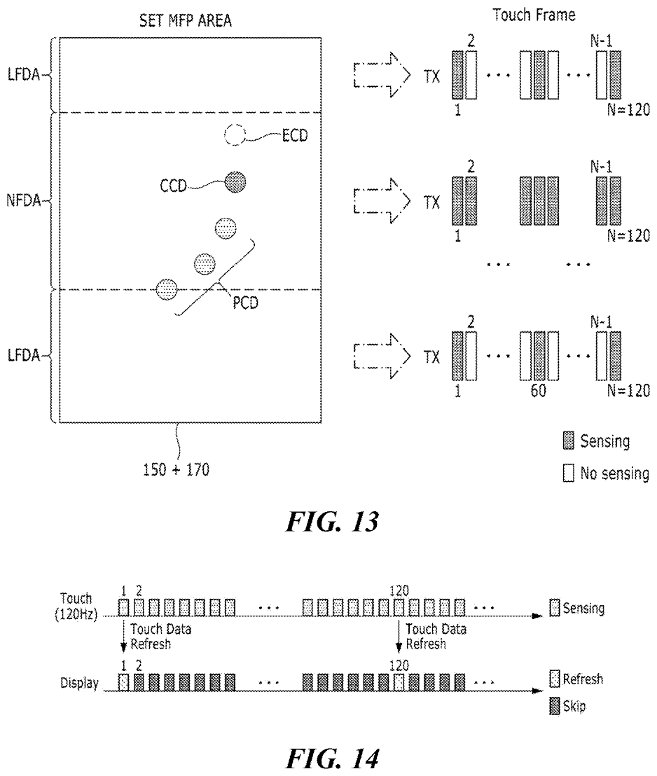

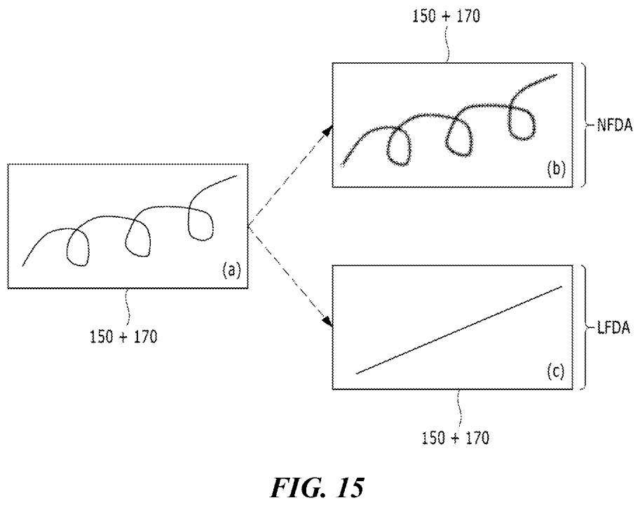

FIG. 13 is a diagram for describing a change in touch frame according to area setting of the display panel including the touchscreen, FIG. 14 is a diagram for describing a problem that may be caused when the display panel is driven at a low frequency, and FIG. 15 is a diagram for describing a difference in power of drawing expression according to driving frequencies of the display panel and the touchscreen.

As illustrated in FIG. 13, according to the integrated control area setting (MFP area setting) scheme described above, the first driving frequency driving area LFDA (low-frequency driving area) and the second driving frequency driving area NFDA (normal-frequency or high-frequency driving area) may be distinguished on the display panel including the touchscreen (150+170).

Referring to touch frames of the second driving frequency driving area NFDA, the touchscreen 170 may be sensed at every frame (for example, from a first frame (1) to an Nth frame (N), where N=120 is taken as an example). In contrast, referring to touch frames of the first driving frequency driving area LFDA, the touchscreen 170 may be sensed at predetermined frame intervals (for example, a first frame (1), a 60th frame (60), and an Nth frame (N)), and may not be sensed during remaining frames. That is, sensing may be performed in the first driving frequency driving area LFDA at a smaller number of frame units than in the second driving frequency driving area NFDA.

Meanwhile, FIG. 13 illustrates an example in which, as a touched position moves from a lower area to a middle area on the display panel including the touchscreen (150+170), the lower area becomes the first driving frequency driving area LFDA and the middle area becomes the second driving frequency driving area NFDA. This may be understood by sequentially following positions of the previous touch coordinates PCD, the current touch coordinates CCD, and the expected touch coordinates ECD.

FIG. 14 illustrates that the touchscreen Touch may be driven based on a normal frequency or a high frequency, and the display panel Display may be driven based on a low frequency. In this case, in the touchscreen Touch, touch data according to sensing may be generated and transmitted at every touch frame. In contrast, in the display panel Display, due to low-frequency driving, refresh for image display may occur only at specific frames such as a first frame 1 or a 120th frame 120, and the remaining frames may be skipped.

In a case such as the above example, even though touch data according to sensing is generated at every touch frame on the touchscreen Touch, refresh intermittently occurs on the display panel, and thus due to this influence, the touch response speed may appear slow or delayed.

Meanwhile, in the above description, refresh means that an operation of applying a data voltage and a gate signal to the display panel for image display is performed, and skip means that, in order to reduce power consumption, an operation of applying a data voltage and a gate signal to the display panel is not performed.

As illustrated in FIG. 15, when drawing is performed in a form such as FIG. 15(a) on the display panel including the touchscreen 150+170, the drawing may appear in a form such as FIG. 15(b) or FIG. 15(c).

FIG. 15(b) is an example that may appear in the second driving frequency driving area NFDA (normal-frequency or high-frequency driving area) of the display panel including the touchscreen 150+170. FIG. 15(c) is an example that may appear in the first driving frequency driving area LFDA (low-frequency driving area) of the display panel including the touchscreen 150+170.

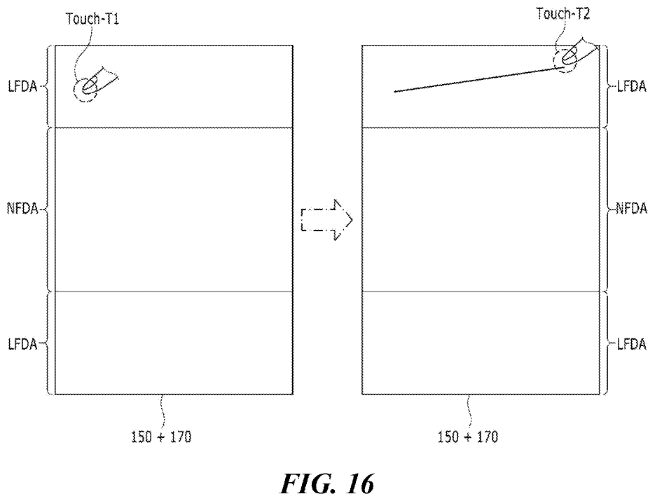

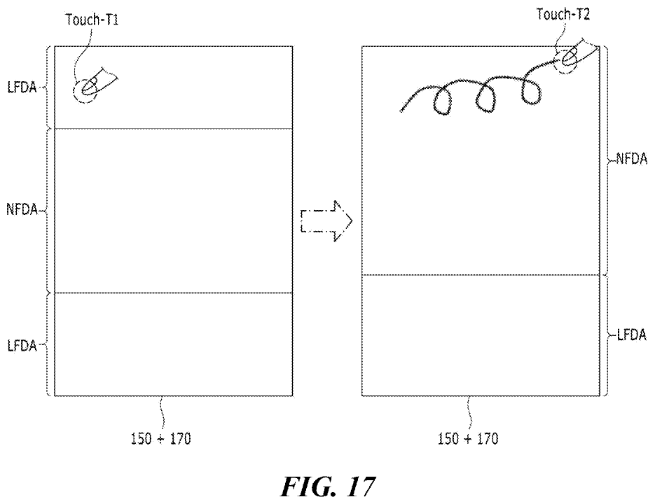

FIG. 16 is a diagram for describing a display panel including a touchscreen according to a comparative example, and FIG. 17 is a diagram for describing a display panel including a touchscreen according to an embodiment.

As illustrated in FIG. 16, when the display panel including the touchscreen 150+170 according to the comparative example is touched in the first driving frequency driving area LFDA (low-frequency driving area) from a first touch time Touch-T1 to a second touch time Touch-T2, and then drawing is performed in a form such as FIG. 15(a), the drawing may appear in an oblique form different from the actual drawing form, such as FIG. 15(c).

In the display panel including the touchscreen 150 +170 according to the comparative example, even though the first driving frequency driving area LFDA (low-frequency driving area) is touched during the first touch time Touch-T1, the driving frequency of the first driving frequency driving area LFDA is not changed thereafter. That is, in the display panel including the touchscreen 150+170 according to the comparative example, even though the driving frequency of the area in which a touch occurs is slow, the driving frequency is not changed to a faster driving frequency, and thus a touch response speed may be regarded as appearing slow.

As illustrated in FIG. 17, when the display panel including the touchscreen 150+170 according to the embodiment is touched in the first driving frequency driving area LFDA (low-frequency driving area) from the first touch time Touch-T1 to the second touch time Touch-T2, and then drawing is performed in a form such as FIG. 15(a), the drawing may appear in a form identical or similar to the actual drawing form, such as FIG. 15(b).

In the display panel including the touchscreen 150 +170 according to the embodiment, as touch occurs in the first driving frequency driving area LFDA (low-frequency driving area) during the first touch time Touch-T1, the first driving frequency driving area LFDA is expanded to the second driving frequency driving area NFDA thereafter, and the driving frequency of the corresponding area is changed. That is, in the display panel including the touchscreen 150+170 according to the embodiment, since the driving frequency of the area in which touch occurs is slow, the driving frequency is changed to a faster driving frequency than the current driving frequency, and thus the touch response speed may be regarded as appearing fast. In addition, as the touch response speed appears fast, touch resolution (power of expression) may be regarded as being improved.

As described above, the present disclosure has an effect of improving touch performance by setting an integrated control area capable of synchronizing driving information of the touchscreen and driving information of the display panel when driving the display panel including the touchscreen based on multiple driving frequencies, and by changing driving conditions of the device based on the integrated control area. In addition, the present disclosure has an effect of enhancing device performance by changing a driving area and a driving frequency of the display panel including the touchscreen according to image characteristics and whether user touch occurs. Furthermore, when an area in which user touch occurs is driven at a low frequency, the present disclosure has an effect of improving touch response speed by changing the driving frequency of the area to a faster driving frequency than the current driving frequency.

The present disclosure has an effect of improving touch performance by setting an integrated control area capable of synchronizing driving information of the touchscreen and driving information of the display panel when driving the display panel including the touchscreen based on multiple driving frequencies, and by changing driving conditions of the device based on the integrated control area. In addition, the present disclosure has an effect of enhancing device performance by changing a driving area and a driving frequency of the display panel including the touchscreen according to image characteristics and whether user touch occurs. Furthermore, when an area in which user touch occurs is driven at a low frequency, the present disclosure has an effect of improving touch response speed and touch resolution (power of expression) by changing the driving frequency of the area to a faster driving frequency than the current driving frequency.

It will be apparent to those skilled in the art that various modifications and variations can be made in the present disclosure without departing from the spirit or scope of the disclosure. Thus, it is intended that the present disclosure cover the modifications and variations of this disclosure including the appended claims and their equivalents.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device comprising:
a display panel including a touchscreen;
a driver configured to drive the display panel including the touchscreen and; and
a control unit configured to control the driver,
wherein the control unit is configured to:
generate an active area setting value for driving the display panel by distinguishing an active area of the display panel based on a data signal of a previous frame and a data signal of a current frame, generate a first touch area setting value for driving a low-frequency driving area at a first driving frequency, derive expected touch coordinates based on previous touch coordinates and the current touch coordinates, and generate a second touch area setting value for driving an area corresponding to the expected touch coordinates at a second driving frequency faster than the first driving frequency,
generate a control signal for synchronously controlling the touchscreen and the display panel based on the active area setting value, the first touch area setting value, and the second touch area setting value, and
change a driving frequency of the low-frequency driving area from the first driving frequency to the second driving frequency, when current touch coordinates on the touchscreen correspond to the low-frequency driving area on the display panel.

2. The display device according to claim 1, wherein the control unit is configured to change at least a part of the low-frequency driving area to the second driving frequency based on the current touch coordinates corresponding to the low-frequency driving area.

3. The display device according to claim 1, wherein the control unit comprises:
an active area setting unit configured to generate the active area setting value,
a touch area setting unit configured to generate the first touch area setting value and the second touch area setting value,
a control area setting unit configured to generate a device control signal based on the active area setting value, the first touch area setting value, and the second touch area setting value, and
a control signal generation unit configured to generate a panel control signal and a touch control signal for synchronously driving the display panel and the touchscreen based on the device control signal.

4. The display device according to claim 1, wherein the control unit is configured to divide the display panel into a plurality of active areas and to drive at least one of the divided active areas at multiple different driving frequencies.

5. The display device according to claim 1, wherein the control unit is configured to generate the control signal such that an area displaying a still image on the display panel is driven at the first driving frequency, and an area displaying a moving image on the display panel is driven at the second driving frequency.

6. The display device according to claim 5, further comprising a touch driver configured to drive the touchscreen,
wherein the touch driver is configured to sense an area driven at the first driving frequency in fewer frame units than frame units of an area driven at the second driving frequency.

7. The display device according to claim 1, wherein the control unit is configured to continuously store the previous touch coordinates, derive the expected touch coordinates by performing data processing on a plurality of stored previous touch coordinates and the current touch coordinates based on modeled values, and the modeled values are prepared based on a movement position of coordinates and a movement speed of coordinates.

8. A method of driving a display device, the method comprising:
generating an active area setting value for driving a display panel by distinguishing an active area of the display panel based on a data signal of a previous frame and a data signal of a current frame;
generating a first touch area setting value for driving a low-frequency driving area on the display panel at a first driving frequency;
deriving expected touch coordinates on a touchscreen based on previous touch coordinates and current touch coordinates, and generating a second touch area setting value for driving an area corresponding to the expected touch coordinates at a second driving frequency faster than the first driving frequency;
generating a control signal for synchronously controlling the touchscreen and the display panel based on the active area setting value, the first touch area setting value, and the second touch area setting value; and
changing a driving frequency of the low-frequency driving area from the first driving frequency to the second driving frequency, when the current touch coordinates on the touchscreen corresponds to the low-frequency driving area on the display panel.

9. The method according to claim 8, wherein, based on the current touch coordinates corresponding to the low-frequency driving area, at least a part of the low-frequency driving area is changed to the second driving frequency.

10. The method according to claim 8, wherein an area displaying a still image on the display panel is driven at the first driving frequency, and an area displaying a moving image on the display panel is driven at the second driving frequency.
